(19) United States
(12) Patent Application Publication
(10) Pub. No.: US 2017/0288960 A1
(43) Pub. Date: Oct. 5, 2017

(54) Cloud Action Center

(71) Applicant: Microsoft Technology Licensing, LLC, Redmond, WA (US)

(72) Inventors: Theron T. Fennel, Woodinville, WA (US); Matthew G. Hidinger, Seattle, WA (US); Lei Xu, Kirkland, WA (US); Yisheng Yao, Sammamish, WA (US)

(73) Assignee: Microsoft Technology Licensing, LLC, Redmond, WA (US)

(21) Appl. No.: 15/405,499

(22) Filed: Jan. 13, 2017

Related U.S. Application Data
(60) Provisional application No. 62/315,561, filed on Mar. 30, 2016.

(51) Int. Cl. H04L 12/24; H04L 12/26; H04L 12/911; G06F 17/30; H04L 29/08

(52) U.S. Cl. CPC H04L 41/0803; G06F 17/30864; H04L 67/22; H04L 41/22; H04L 69/324; H04L 47/82; H04L 43/08

(57) ABSTRACT

Examples of the present disclosure describe systems and methods of providing cloud-based activity information. In aspects, a notification may be generated on a client device of a user. The notification may be transmitted to a cloud-based server via an activity feed. The cloud-based server may use the notification to identify a mapping of the user to multiple devices associated with the user. The cloud-based server may then forward the notification to one or more of the identified devices. In at least one example, when the user dismisses the notification using any of the identified devices, the notification is automatically dismissed on the remaining identified devices.

### CROSS-REFERENCE TO RELATED APPLICATIONS

This application claims the benefit of U.S. Provisional Application Ser. No. 62/315,561, filed Mar. 30, 2016, entitled “Cloud Action Center,” which application is incorporated herein by reference in its entirety.

### BACKGROUND

An action center is a central place on a computing device to view activity information associated with the device. An action center provides messages related to security, maintenance settings and other notification events on a user's device. Typically, activity information is delivered to devices individually. As a result, users are often not notified of messages and/or notifications in a timely fashion, and users are required to switch between multiple devices to respond to or dismiss the same notifications or messages.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

This summary is provided to introduce a selection of concepts in a simplified form that are further described below in the Detail Description section. This summary is not intended to identify key features or essential features of the claimed subject matter, nor is it intended to be used as an aid in determining the scope of the claimed subject matter.

Examples of the present disclosure describe systems and methods of providing cloud-based activity information. In aspects, a notification may be generated on a client device of a user. The notification may be transmitted to a cloud-based server via an activity feed. The cloud-based server may use the notification to identify a mapping of the user to multiple devices associated with the user. The cloud-based server may then forward the notification to one or more of the identified devices. In at least one example, when the user dismisses the notification using any of the identified devices, the notification is automatically dismissed on the remaining identified devices.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an overview of an example system for implementing cloud action center techniques as described herein.

FIG. 2 illustrates an example interplay between a client devices and a server device in a cloud action center system as described herein.

FIG. 3 illustrates an example method of forwarding activity information in a cloud action center system as described herein.

FIG. 4 illustrates an example method of dismissing activity information in a cloud action center system as described herein.

FIG. 5 illustrates an example method of activating actionable content in a cloud action center system as described herein.

FIG. 6 is a block diagram illustrating example physical components of a computing device with which aspects of the disclosure may be practiced.

FIGS. 7A and 7B are simplified block diagrams of a mobile computing device with which aspects of the present disclosure may be practiced.

FIG. 8 is a simplified block diagram of a distributed computing system in which aspects of the present disclosure may be practiced.

FIG. 9 illustrates a tablet computing device for executing one or more aspects of the present disclosure.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

The present disclosure provides systems and methods of providing a cloud action center. A cloud action center, as used herein, may refer to an infrastructure that provides cloud-based storage of a user's activity information from multiple devices, an interface to access such activity information, and/or an engine to synchronize changes to such activity information. As such, the cloud action center may be implemented as a distributed network of devices. In aspects, activity information may be generated on a client device of a user. Activity information, as used herein may, refer to one or more of a notification, a task, a tile, a toast, a badge, an information card and the like. In examples, activity information may comprise or be otherwise associated with assets. An asset, as used herein, may refer to information specified by an activity information publisher where the information refers to data in an application's package, an application's isolated storage locations, and/or resource data within an activity information payload. The client device may store a copy of the activity information or data related to the activity information in a data store accessible to the client device. The client device may then pass the activity information to an activity feed. An activity feed, as used herein, is a communication channel for communicating activity information for a device. The activity feed may be associated with an activity feed service on a cloud-based server device.

In some aspects, the cloud-based server may use the activity information provided in the activity feed to identify the user, group and/or device originating the activity information. The identified information may be used by the cloud-based server to manage a mapping of the user to multiple devices associated with the user. Based on the mapping information, the cloud-based server may identify one or more client devices in which to transmit activity information. The cloud-based server may use the activity feed service to forward the activity information to the identified client devices. The cloud-based server may also store the activity information in a data store accessible to the server device. In examples, the data store may comprise activity information for a plurality of devices associated with the user. The data store information may be used by an interface provided by the server device.

In some aspects, after receiving the forwarded activity information on an identified client device, the user may process the forwarded activity information using the receiving client device. In at least one example, the receiving client device may be used to, for example, dismiss a notification. The receiving client device may use an activity feed to communicate the dismissal of the notification to the cloud-based server. The cloud-based server may then use the activity feed service to dismiss the notification on each of the identified client devices. In another example, the receiving client device may be used to, for example, remotely activate the originating device. The receiving client device may use a command service associated with the cloud action center, instead of the activity feed service, to communicate with the originating device.

Accordingly, the present disclosure provides a plurality of technical benefits including but not limited to: aggregating activity information in cloud-based environments; synchronizing activity information across multiple user devices; improving activity information delivery timeliness; improving functional activity information handling on user devices; decreasing resource costs associated with context changes and lost productivity; improving user experience; reducing the bandwidth and power consumption of the devices within the system and improving efficiency and quality for applications/services utilizing examples of the present disclosure, among other examples.

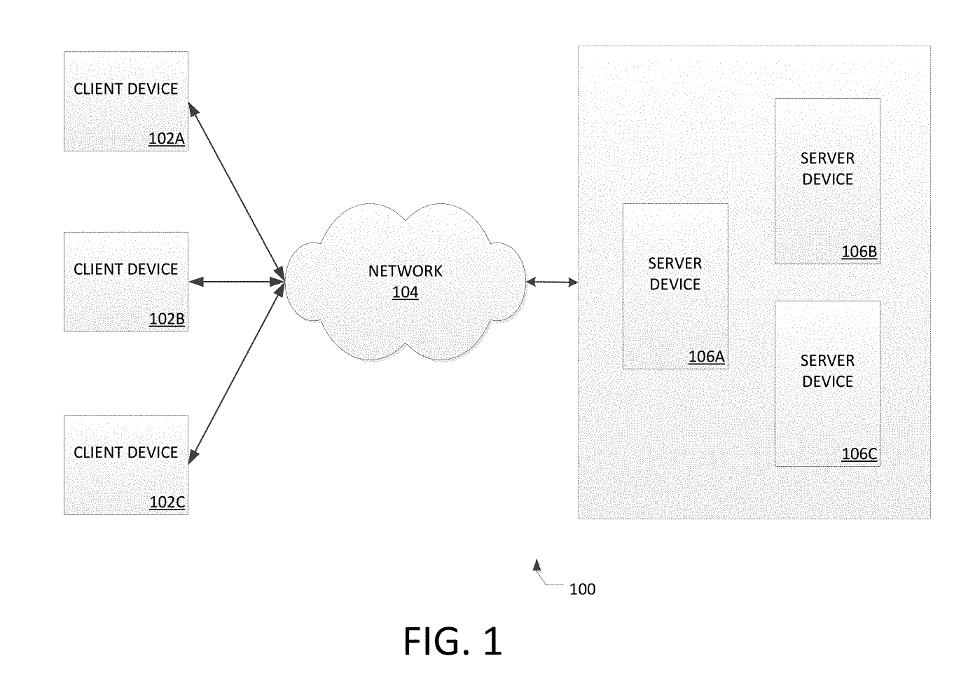

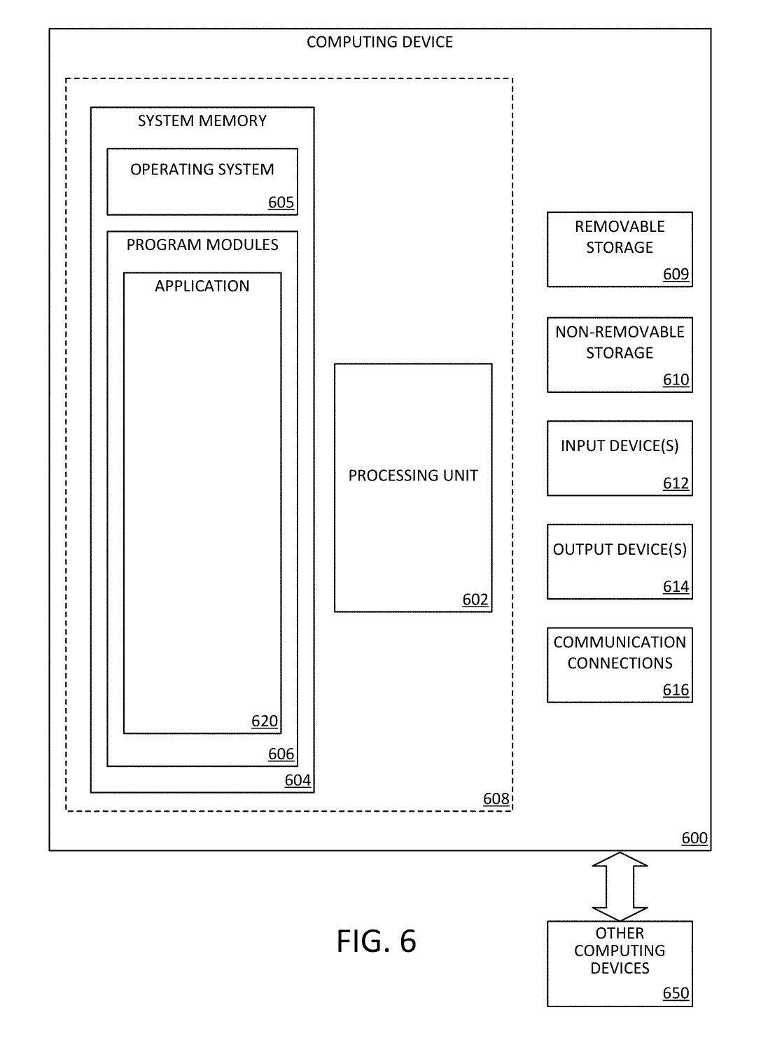

FIG. 1 illustrates an overview of an example system for implementing personalization techniques for natural language systems as described herein. Example system 100 presented is a combination of interdependent components that interact to form an integrated whole for personalizing natural language systems. Components of the systems may be hardware components or software implemented on and/or executed by hardware components of the systems. In examples, system 100 may include any of hardware components (e.g., used to execute/run operating system (OS)), and software components (e.g., applications, application programming interfaces (APIs), modules, virtual machines, runtime libraries, etc.) running on hardware. In one example, an example system 100 may provide an environment for software components to run, obey constraints set for operating, and makes use of resources or facilities of the system 100, where components may be software (e.g., application, program, module, etc.) running on one or more processing devices. For instance, software (e.g., applications, operational instructions, modules, etc.) may be run on a processing device such as a computer, mobile device (e.g., smartphone/phone, tablet) and/or any other electronic devices. As an example of a processing device operating environment, refer to the example operating environments depicted in FIGS. 6-9. In other examples, the components of systems disclosed herein may be spread across multiple devices. For instance, input may be entered on a client device and information may be processed or accessed from other devices in a network such as one or more server devices.

As one example, the system 100 comprises client device 102A, client device 102B, client device 102C, distributed network 104, and a distributed server environment comprising one or more servers such as server device 106A, server device 106B and server device 106C. One of skill in the art will appreciate that the scale of systems such as system 100 may vary and may include more or fewer components than those described in FIG. 1. In some examples, interfacing between components of the system 100 may occur remotely, for example, where components of system 100 may be spread across one or more devices of a distributed network.

In aspects, client device 102A may be configured to receive input from user via a user interface component or other input means. Examples of input may include voice, visual, touch and text input. Client device 102A may further be configured to generate activity information. In some examples, the activity information may be generated using at least a portion of the input. Client device 102A may further be configured to process the activity information and to store a copy of the activity information in a data store. In at least one example, processing the activity information may include packaging the activity information using, for example, metadata. After processing the activity information, client device 102A may provide the processed activity information to an activity feed accessible to client device 102A. The activity feed may transmit the activity information via distributed network 104 to one or more computing devices in a cloud-based environment, such as server devices 106A, 106B and 106C. Client devices 102B and 102C may be similarly configured to client device 102A, but may be a different device type from client device 102A. For example, a user may provide input or access content using client device 102A (e.g., a PC), client device 102B (e.g., a mobile phone) and/or client device 102C (e.g., a tablet). Each of the client devices may be associated with an activity feed for transmitting activity information to the cloud-based environment.

Server device 106A may be configured to receive and process activity information from a client device. In aspects, processing the activity information may include parsing the activity information to identify, for example, identifying information associated with a user and/or client device. Server device 106A may use the identifying information to manage a mapping of the user to multiple client devices associated with the user. In some examples, the mapping may indicate the client devices that are currently (or have recently) accessed an account of the user, the client devices that are authorized to share and/or receive information (such as activity information), the synchronization information for client devices, and/or one or portions of the activity information stored on the client devices. Based on the mapping information, the server device 106A may identify one or more client devices to receive activity information. Server device 106A may use an activity feed service to forward the activity information to the identified client devices.

Server device 106A may also be configured to store the received activity information in a data store. The data store may comprise at least activity information for a plurality of client devices associated with the user. In a particular example, the data store may include notifications that have been received from client devices 102A, 102B and 102C. In aspects, server device 106A may have access to a cloud-based action center. The cloud-based action center may also be accessible to server devices 106B and 106C. For example, the activity information stored by server devices 106A, 106B and 106C may be accessible by each respective server device and/or the cloud-based action center. The cloud-based action center may use the activity information stored by the server devices to provide a notification hub for a user (e.g., the user of the originating device, an application developer, etc.).

Client devices 102A, 102B and 102C may further be configured to receive activity information from server devices, such as server device 106A. In aspects, client device 102B may receive activity information that originated on client device 102A and was transmitted to server device 106A. Client device 102B may then be used to address the activity information such that the activity information is similarly addressed by other client devices of the user. For example, a user may dismiss a notification received by client device 102B. As a result, the activity feed associated with client device 102B may send an indication of the notification dismissal to server device 106A. In turn, server device 106A may send the indication of the notification dismissal to client devices 102A and 102C. Client device 102A and 102C may then remove the notification from their respective data store, thereby dismissing the notification.

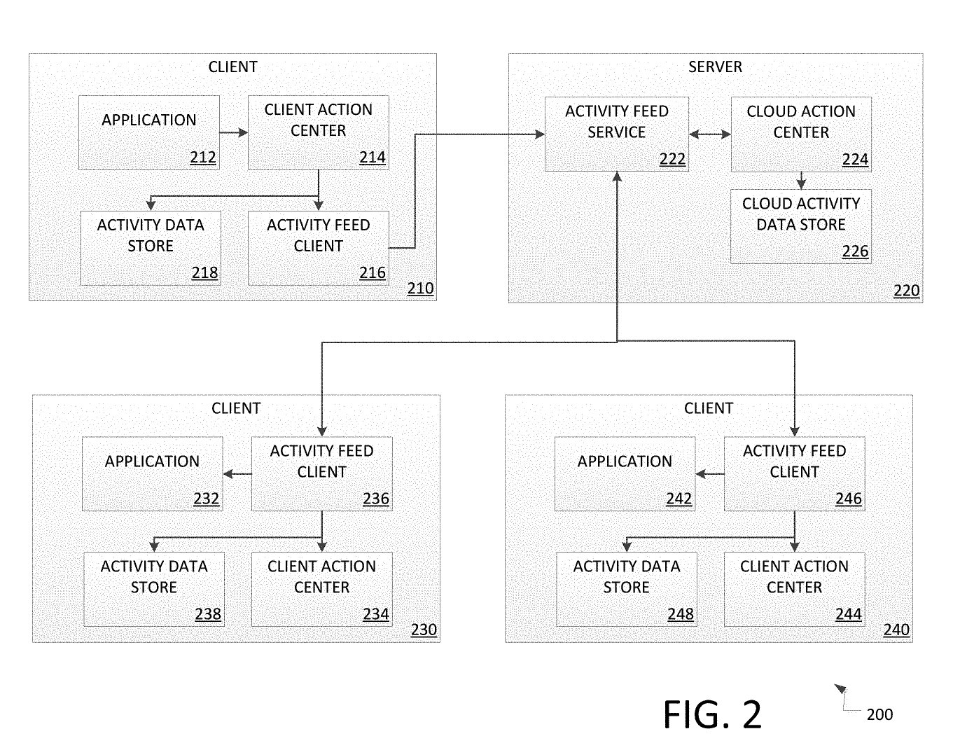

FIG. 2 illustrates an overview of an example interplay between client devices 210, 230 and 240 and a server device 220 implementing a cloud action center, as described herein. The cloud action center techniques implemented by client devices 210, 230 and 240 and/or server device 220 may comprise the cloud action center techniques and input described in FIG. 1. In alternative examples, a single system (comprising one or more components such as processor and/or memory) may perform processing described in systems 100 and 200, respectively. Further, client device 210, 230 and 240 and/or server device 220 may comprise a user interface component as described in the description of FIG. 1.

With respect to FIG. 2, client device 210 may comprise application 212, client action center 214, activity feed client 216 and activity data store 218, each having one or more additional components. Application 212 may be configured to receive and/or generate activity information. For example, application 212 may be a calendaring application that generates a reminder for an upcoming event. Client action center 214 may be configured to receive activity information from services and applications, such as application 212. The received activity information may be processed and presented to a user via, for example, an interface accessible to client action center 214. The interface may enable interaction (e.g., navigation, selection, dismissal, etc.) with the received activity information. In examples, client action center 214 may provide one or more APIs or listening agents to services and/or applications such that activity information generated by the services and/or applications are automatically sent to cloud action center 214. In other examples, client action center 214 may be operable to poll the services and/or applications to retrieve the activity information. Client action center 214 may further be configured to transmit the activity information to one or more of activity feed client 216 and activity data store 218. Activity data store 218 may be configured to store at least activity information originating on and/or received by client device 210. For example, activity data store 218 may store notifications according to one or more of the originating service or applications, a user identification, device identification, a completion status of the notification, and/or date/time. Activity feed client 216 may be configured to transmit activity information to and/or receive activity information from an activity feed service (discussed in more detail below). For example, activity feed client 216 may package activity information with metadata and local assets, and APIs to resolve the metadata and/or local assets; thereby, generating an activity information payload. Activity feed client 216 may then transmit the activity information payload to an activity feed service in a cloud-based environment.

Server device 220 may comprise activity feed service 222, cloud action center 224 and cloud activity data store 226. Activity feed service 222 may be configured to receive and process activity information payloads. For example, activity feed service 222 may parse an activity information payload to identify the user and/or device that originated the activity information. The identified user and/or device information may be used to manage a mapping of the user to multiple devices associated with the user. Based on the mapping information, the server device 220 may identify one or more client devices in which to transmit the activity information payload. Activity feed service 222 may further be configured to transmit the activity information payload to cloud action center 224.

Cloud action center 224 may be configured to process the APIs in the activity information payload for each of the client devices identified by activity feed service 222. For example, based on the mapping information managed by activity feed service 222, cloud action center 224 may determine that an activity information payload is to be forwarded to client device 230 (e.g., a mobile phone) and 240 (e.g., a tablet). Cloud action center 224 may configure an activity information payload that includes (or only includes) the APIs and assets for the respective client devices. Cloud action center 224 may pass the device-specific payloads to activity feed service 222 to be transmitted to the corresponding client devices. In some aspects, cloud action center 224 may alternately or additionally use the activity information payload to generate and/or modify a notification hub or center that is accessible from cloud action center 224. The notification hub may provide an interface for viewing and manipulating activity information, modifying user, application and/or system-level settings, providing activity delivery details, and/or developing, for example, first- and/or third-party content. The notification hub may also provide access to a data store, such as cloud activity data store 226. Cloud activity data store 226 may comprise activity information payloads and/or activity information payload data from multiple devices associated with a user. In examples, activity feed service 222 and/or cloud action center 224 may access and provide data to cloud activity data store 226.

In some examples, cloud action center 224 may further be configured to prevent duplicate activity information from being transmitted to client devices. For instance, cloud action center 224 may include logic, a rule set, a pattern-matching algorithm or a statistical model that compares received activity information to data stored in cloud activity data store 226. In a particular example, the comparison may include evaluating notification information (e.g., a timestamp, notification type, notification message, user identification, etc.) from an application against application data in the cloud activity data store. In such example, fuzzy logic or predefined minimum threshold values, for instance, may be used in the comparison. In aspects, when cloud action center 224 determines a match (or a probable match) between the received activity information and the stored data, cloud action center 224 may remove an activity information payload or otherwise prevent an activity information payload from being transmitted to a client device that previously reported or is currently storing the activity information. In some aspects, duplication prevention techniques may additionally or alternately be performed by the client device.

Client devices 230 and 240 may comprise components that are configured similarly to those discussed above with respect to client device 220. For example, client device 230 may comprise application 232, client action center 234, activity feed client 236 and activity data store 238, each having one or more additional components. Activity feed client 236 may be configured to transmit activity information to and/or receive activity information from an activity feed service, such as activity feed service 222. In aspects, after receiving activity information (such as an activity information payload) from the activity feed service, activity feed client 236 may unpackage the activity information payload. Unpackaging the activity information payload may include parsing the payload into at least activity information, metadata, assets and/or APIs. In some aspects, at least some portions of the unpackaged activity information may transmitted to one or more of application 232, client action center 234 and activity data store 238. For example, the APIs provided in the activity information payload received by client device 230 may comprise data and/or instructions for resolving the assets provided in the activity information payload on client device 230. In at least one example, resolving an asset includes determining an application, service, device type, storage location and/or resource associated with activity information. The resolved asset and associated APIs may then be used to add the corresponding activity information to the specified device.

Client devices 210, 230 and 240 may further be configured to resolve or otherwise act upon the activity information received from server device 220. In some aspects, when activity information has been forwarded using activity feed service 222 to one or more client device associated with a user, the activity information may be accessed using any of the one or more client devices. An action taken against the activity information on one client device may then be propagated to the other client devices using one or more components of server device 220. For example, a notification originating on client device 210 may be forwarded to client devices 230 and 240 using the activity information forwarding techniques described above. A user may access the notification using client device 240 and indicate an intention to dismiss the notification using, for example, application 242, client action center 244 or activity data store 248. In response, client device 240 may package the dismissal notification as described above and transmit the dismissal notification payload to activity feed service 222 using activity feed client 246. In some examples, the indication of an intention to dismiss the notification may cause client device 240 to remove the notification from one or more components of client device 240. Upon receiving the dismissal notification payload, server device 220 may update cloud activity data store 226 to, for example, remove the associated notification from cloud activity data store 226. Server device 220 may also use cloud action center 224 to determine the client devices of the user that have not yet received the dismissal notification and/or dismissed the notification. Server device 220 may then use activity feed service 222 to transmit the dismissal notification payload to client devices 210, 230 and 240 via the respective activity feed clients (e.g., activity feed clients 216, 236 and 246). The client devices receiving the dismissal notification payload may then dismiss the notification identified by the notification payload.

In some aspects, only a subset of client devices associated with a user, group or profile may be configured to resolve or otherwise act upon the activity information received from server device 220. In such aspects, a client device that is not configured to resolve activity information may communicate with a client device that is configured to resolve activity information via means separate from, or in addition to, the activity feed client/service mechanics. For example, a task (or task details) originating on client device 210 may be forwarded to client devices 230 and 240 using the activity information forwarding techniques described above. The task may be specific to a particular service or application, such as application 212, which may not be installed on or otherwise accessible to one or more of client devices 230 and 240. In such an example, a user may access the task using, for example, client device 240 and indicate an intention to complete or otherwise satisfy the task. In response, client device 240 may determine that one or more of client devices 230 and 240 are not operable to complete the task. Client device 240 may then establish or identify a communication channel to the originating device (e.g., client device 210). In a particular example, the communication channel may be a direct link to the originating device. In another example, the communication channel may be establish via a command service using one or more portions of the communication framework described in systems 100 and 200. Client device 240 may generate a task completion request and/or other information related to the completion of the task, and may transmit such information to client device 210. Upon receiving the information, client device 210 may perform the task using the specified service or application. Client device 210 may then prepare a response payload including, for example, an indication of task completion, a result set, or the like. In one example, client device 210 may transmit the response payload directly to client device 240 using the communication channel described above. In another example, the client device 210 may transmit the response payload using activity feed client 216 and activity feed service 222, as described above.

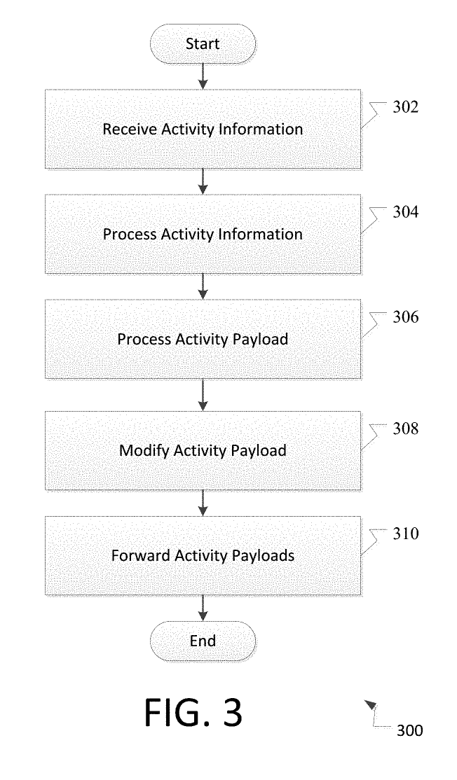

FIGS. 3-5 illustrates example methods of forwarding activity information using a cloud action center in a cloud action center environment as described herein. In aspects, methods 300-500 may be executed by an example system such as system 100 of FIG. 1. In examples, methods 300-500 may be executed on a device comprising at least one processor configured to store and execute operations, programs or instructions. However, methods 300-500 are not limited to such examples. In other examples, methods 300-500 may be performed on an application or service for providing query resolution. In at least one example, methods 300-500 may be executed (e.g., computer-implemented operations) by one or more components of a distributed network, for instance, a web service/distributed network service (e.g. cloud service) to activity information management techniques for a cloud action center system.

FIG. 3 illustrates an example method of forwarding activity information in a cloud action center system as described herein. Example method 300 begins at operation 302 where activity information may be received by a client device. In aspects, the activity information may be received by, for example, application 212 of client device 210. The activity information may comprise one or more of a notification, a task, a tile, a toast, a badge, an information card, and the like. The activity information may comprise or be otherwise associated with local assets and/or APIs. A client device may receive and/or generate activity information in response to receiving input from, for example, a user, an application, a service, or a separate device.

At operation 304, the activity information may be processed. In aspects, the activity information may be provided to an action center on the client device, such as client action center 214. The action center may store the activity information in a data store accessible to the client device, such as activity data store 218. The activity information may be organized and stored according to, for example, originating application, user identification, date/time, activity information type, etc. The action center may also provide the activity information to an activity feed, such as activity feed client 216. The activity feed may package the activity information with metadata and information to resolve the local assets associated with the activity information on different devices. The activity feed may be in communication or otherwise accessible to an activity feed service, such as activity feed service 222, of a cloud-based computing environment. The activity feed may transmit the packaged activity information (e.g., activity information payload) via the activity feed service to a cloud-computing device, such as server device 220.

At operation 306, the activity feed service may receive and process the packaged activity information. In aspects, the activity feed service may use pattern matching techniques, a rule set or a machine-learning algorithm to parse the received packaged activity information to identify data, such as a user identification, an originating device, an originating device type, an originating application or service, an activity information type, etc. The activity feed service may use the identified data to manage a mapping of user data to client devices associated with the user. For example, the activity feed service may compare a user identification identified in the activity information to a data store of previously-detected user and device information. Based on the comparison, the activity feed service may determine that a user or user account has previously registered or accessed a particular service or account using a PC, a mobile phone and a tablet device. The PC, mobile phone and tablet device may each have different hardware and/or software configuration. In aspects, the mapping managed by the activity feed service may be stored, for example, in a file, a database or in a memory space accessible to a cloud-computing device. At least some portion of the mapping information and the activity information may then be provided to a cloud-based action center, such as cloud action center 224.

At operation 308, the cloud-based action center may configure or modify features of the activity information. In aspects, the cloud-based action center may use the mapping information and the activity information to determine the client devices of the user that have not yet received and/or processed the activity information. The cloud-based action center may then configure and/or package activity information based on the features and/or characteristics of the respective client devices. For example, the cloud-based action center may receive a notification from a PC device associated with a user. The cloud-based action center may determine that the notification has not yet been received by a mobile phone or a tablet device associated with the user. Accordingly, the cloud-based action center may configure or modify two payloads (or portions of the two payloads) to include, for example, device-specific APIs to resolve local assets in the received activity information on the mobile phone and tablet device, respectively. In at least one example, the PC, the mobile phone and/or the tablet device may have disparate configurations or components, such as operating systems, operating system versions, software packages, hardware components, etc. In such an example, the cloud-based action center may be configured to provide payloads that resolve the local assets in the specific environments of the mobile phone and tablet device; thereby providing cross-platform notification delivery.

In some aspects, determining activity information has not yet been received by a device may include accessing a cloud-based activity information data store, such as cloud activity data store 226. For example, when an activity feed service provides activity information to a cloud action center, the cloud action center may store the information in a cloud-based activity information data store. The stored information may correlate the activity information with a user, a user device, a date/time value, an activity information type, etc. In a particular example, the information may be stored in a database comprising the columns and values:

“user_ID=>Will_4321”
“date=>03/01/2016”

### “Originating Device=>PC”

### “Device Type=>PC”

### “Activity Type=>Notification”

### “Message=>Missed Phone Call”

The cloud action center may then search the cloud-based activity information data store to determine whether there are entries for client devices that correspond to the activity information identified in the received activity information payload. For instance, in the above example, the cloud action center may search the database to determine whether the mobile phone and/or tablet device associated with the user also reported a “Missed Phone Call” notification during a particular time period. When it is determined that the mobile phone and/or tablet device have not reported the notification, the cloud action center may configure a payload for each respective device, as described above. In some aspects, determining whether stored data corresponds to received activity information may include the use of pattern-matching techniques, fuzzy logic, machine-learned models and/or one or more weighting algorithms. For example, a user's PC and mobile phone, each having different operating systems, may receive a notification for the same missed call event. Although the “Activity Type” for both devices may be “Notification,” the “Message” for the PC may be “Missed Phone Call,” whereas the “Message” for the mobile phone may be “Call Missed.” In this example, the cloud action center may use a machine-learned model to evaluate, for example, matching or similar terms in the “Message,” the proximity of terms in the “Message,” timestamps in the notification and/or the value of “Activity Type.” Based on the evaluation, the machine-learned model may determine that “Missed Phone Call” and “Call Missed” refer to the same activity or event (e.g., a particular missed call).

At operation 310, the activity feed service may forward an activity information payload to a client device. In aspects, the cloud action center may provide one or more activity information payloads to the activity feed service. Each of the activity information payloads may correspond to a different client device. The activity feed service may transmit the activity information payloads to respective client devices, such as client devices 230 and 240. In examples, upon receiving an activity information payload via an activity feed, such as activity feed clients 236 and 246, a client device may unpackage the activity information payload. Portions of the unpackaged activity information may then be transmitted to one or more components of the client device, such as applications 232 and 242, client action centers 234 and 244 and activity data stores 238 and 248. For example, a client device (e.g., a mobile phone) may receive a notification payload comprising one or more device-specific APIs and assets. The client device may use the device-specific APIs to resolve the assets on the client device; thereby, storing the notification on the client device.

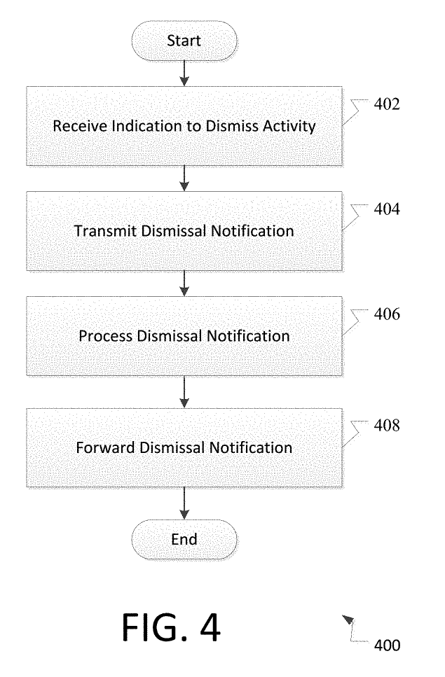

FIG. 4 illustrates an example method of dismissing activity information in a cloud action center system as described herein. Example method 400 begins at operation 402 where an indication to dismiss activity information may be received by a client device. In aspects, one or more client devices associated with a user, such as client devices 210, 230 and 240, and a server device, such as server device 220, may store activity information originating from the same action or event. An indication to dismiss the activity information may be received on one of the client devices. The client device receiving the indication may then process the dismissal notification. For example, a laptop, a mobile phone and a tablet device may be associated with a user. A game notification originating from the laptop may be forwarded to the mobile phone and tablet device. A gaming service (or application) accessible to the mobile phone and/or the tablet device may receive an indication to dismiss the game notification. In response to receiving the indication to dismiss, the receiving client device (e.g., mobile phone and/or the tablet device) may provide the dismissal indication to an activity feed, such as activity feeds 216, 236 and 246. The activity feed may package the dismissal indication into a dismissal payload, as described above. In some aspects, processing the dismissal notification may include causing the client device receiving the indication to remove the notification from the client device or from portions of the client device.

At operation 404, the dismissal notification may be transmitted to a cloud action center. In aspects, the client device may use an associated activity feed to provide the dismissal notification to an activity feed service, such as activity feed service 222. The activity feed service may parse (or cause to be parsed) the dismissal notification to identify the user and/or device that originated the dismissal. The activity feed service may compare this information to a mapping between the user and multiple devices associated with the user in order to determine client devices in which to transmit the dismissal notification. The activity feed service may then provide the dismissal notification to a cloud-based action center, such as cloud action center 234. For example, the activity feed service may receive a game notification dismissal. The activity feed service may parse the game notification dismissal and use the user identification information to determine that the user is associated with a PC, a laptop, a mobile phone, a tablet device and an electronic reading (e-reader) device. The activity feed service may also use to parsed information to determine that only the laptop, mobile phone and tablet device have installed (or are compatible with) the gaming service. Based on these determinations, the activity feed service may determine that the game notification dismissal is to be forwarded to the laptop, mobile phone and tablet device. In some aspects, the client device that originated the dismissal notification may remove the notification from the client device prior to transmitting the dismissal notification to the activity feed service. In such aspects, the dismissal notification may comprise an indication that the notification has been removed from the client device.

At operation 406, the dismissal notification may be processed by the cloud action center. In aspects, the cloud action center may receive a dismissal notification from the activity feed service. The cloud action center may then process the dismissal notification. In examples, processing the dismissal notification may include removing the notification from a cloud data store, such as cloud activity data store 226, storing activity information for a plurality of client devices associated with a user. In at least one aspect, processing the dismissal notification may further include configuring dismissal notification payloads for each client device determined by the activity feed service. For example, upon receiving a game notification dismissal originating from a laptop, the cloud action center may identify an entry in a cloud activity database corresponding to the receipt of the game notification by the laptop. The cloud action center may remove the entry or mark the entry for removal. In at least one example, the cloud action center may search the cloud activity database to identify other client devices that received and/or stored the notification. The cloud action center may use the search results to remove or mark entries corresponding to the identified client devices. In some aspects, the cloud action center may configure a dismissal notification payload for each device determined by the activity feed service and/or identified by the cloud action center, as described above. The dismissal notification payloads may comprise device-specific data and/or instructions for removing notifications on respective client devices.

At operation 408, a dismissal notification payload may be forwarded to a client device. In aspects, one or more dismissal notification payloads may be forwarded to respective client devices. The client devices may process the dismissal notification payloads (as described above) to remove (e.g., dismiss) the notification. For example, a cloud action center may configure a dismissal notification payload for a mobile phone and a tablet device. Each dismissal notification payload may include device- or operating system-specific configuration data. The cloud action center may transmit the dismissal notification payloads to the respective devices using the activity feed service. Upon receiving the dismissal notification payloads, the mobile phone and a tablet device may use dismissal notification payload configuration data to remove the corresponding notification from the devices.

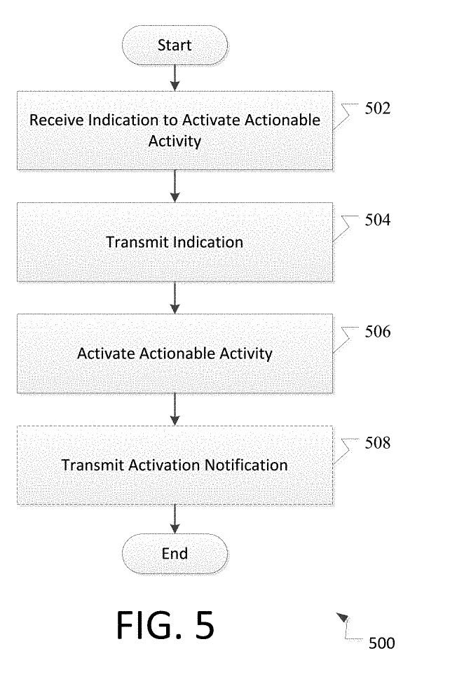

FIG. 5 illustrates an example method of activating actionable content in a cloud action center system as described herein. Example method 500 begins at operation 502 where an indication to initiate actionable activity information may be received by a client device. In aspects, one or more client devices associated with a user, such as client devices 210, 230 and 240, and a server device, such as server device 220, may store activity information originating from the same action or event. In examples, the activity information may be actionable such that, for example, clicking on the activity information or on an associated link may cause a computing device to initiate a task or event associated with the activity information. In at least one aspect, an indication to initiate the activity information may be received by one of the client devices. The client device receiving the indication may then process the indication. Processing the indication may include identifying the device originating the activity information, identifying a device operable to perform the activity information, performing an activity or event associated with the activity information and/or generating an activity information payload (as described above). In some examples, processing the indication may additionally or alternately include transmitting the indication to initiate actionable activity information (or a notification based thereon) to a server device and/or one or more separate client devices. In such examples, an action center associated with the receiving device may store the indication/notification and/or use the indication/notification to prevent other devices from initiating the actionable activity information. For example, a laptop, a mobile phone and a gaming console may be associated with a first user. A game invite originating from a second user's gaming console (or an associated service) may be forwarded to the first user's laptop, mobile phone and gaming console. The mobile phone may be used to indicate an intention to accept the game invite, thereby allowing the first user to join the second user's game. The mobile phone may then generate a message/notification indicating the intention to accept the game invite. The message/notification may comprise data and/or instructions that allow the first user's gaming console to join the second user's game session. The data and/or instructions may also prevent other devices from activating or reactivating the game invite after a first activation has been detected.

At operation 504, the indication to initiate the activity information may be transmitted. In aspects, the indication to initiate the activity information or an associated activity information payload may be transmitted to a separate device. In some examples, an activity feed associated with the transmitting client device, such as activity feed clients 216, 236 and 246, may be used to transmit the information to other devices. The activity feed may transmit the information to an activity feed service, such as activity feed service 222, which may further transmit the information to activity feeds associated with other client devices. In other examples, a connection that does not use the activity feed service may be established and/or used to transmit the information to a separate device. For instance, the transmitting client device may use a direct connection to a separate client device. Alternately, the transmitting client device may use a command service used to remotely activate an application, service or activity information on a remote device. In at least one example, the command service may be associated with a server device comprising a cloud action center, such as cloud action center 224.

At operation 506, actionable activity information may be activated. In aspects, a client device may receive or generate an indication to initiate activity information associated with the client device. The receiving client device may parse the indication to identify or otherwise determine data and/or instructions for activating the activity information. The client device may then activate the activity information or a task/event associated with the activity information. For example, a user's mobile phone may be used to indicate an intention to accept a game invite on a gaming console. The mobile phone may transmit the intention to the user's gaming console. Upon receiving the intention, the gaming console may use data/instructions transmitted with the intention to activate, for example, the gaming console, a game and/or service associated with the gaming console, a game lobby or match, a television or display unit attached to the gaming console, and the like; thereby, allowing the first user to accept the game invite. In another example, a user's mobile phone may be used to indicate an intention to view a social media post. Based on the intention, the mobile phone may activate a social media application installed on the mobile phone. The social media application may then launch or otherwise provide access to the social media post.

At optional operation 508, an activation notification may be transmitted. In aspects, a client device activating activity information or a task/event associated with the activity information, may transmit a notification of the activation. The notification may be transmitted to one or more devices associated with a user and/or a server device associated with a cloud action center. The notification may comprise data and/or instructions that prevent other devices from activating or reactivating the activity information when, for example, a first activation has been previously detected. For example, upon joining a user to a gaming session indicated by a game invite, a gaming console may generate and transmit a notification that the game invite has been accepted and/or that the user has joined the specified gaming session. The notification may comprise data and/or instructions that prevent other devices and/or users from activating or reactivating the game invite. Such prevention techniques may include disabling a link or executable file, removing a notification comprising actionable activity information from a device, etc. In another example, upon launching a social media post using a mobile phone, the mobile phone may generate and/or transmit a notification that the social media post has viewed. The notification may cause devices receiving the notification to remove activity information corresponding to an invitation to view the social media post.

FIGS. 6-9 and the associated descriptions provide a discussion of a variety of operating environments in which aspects of the disclosure may be practiced. However, the devices and systems illustrated and discussed with respect to FIGS. 6-9 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above including the client computing devices 102A-C and the server computing devices 106A-C. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program modules 606 suitable for running software application 620, such as one or more components in regards to FIG. 2. The operating system 605, for example, may be suitable for controlling the operation of the computing device 600. Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., unified messaging application 620) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

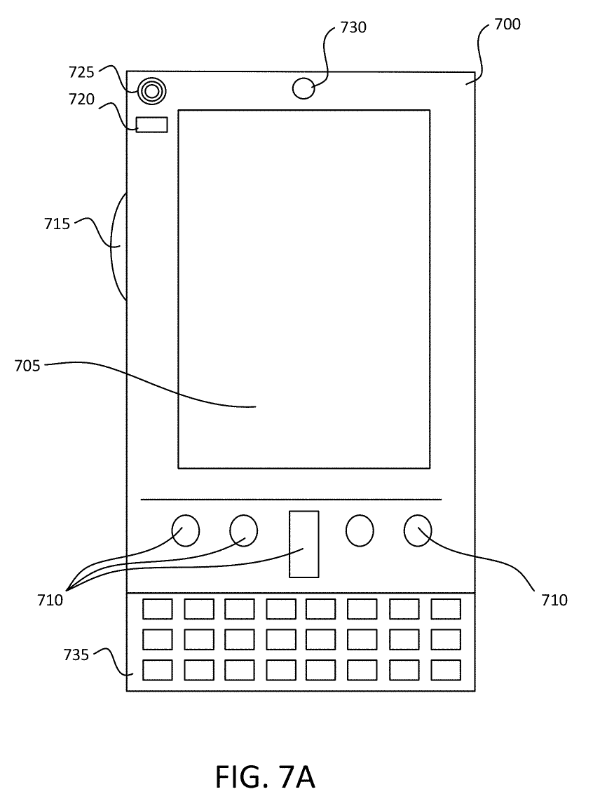

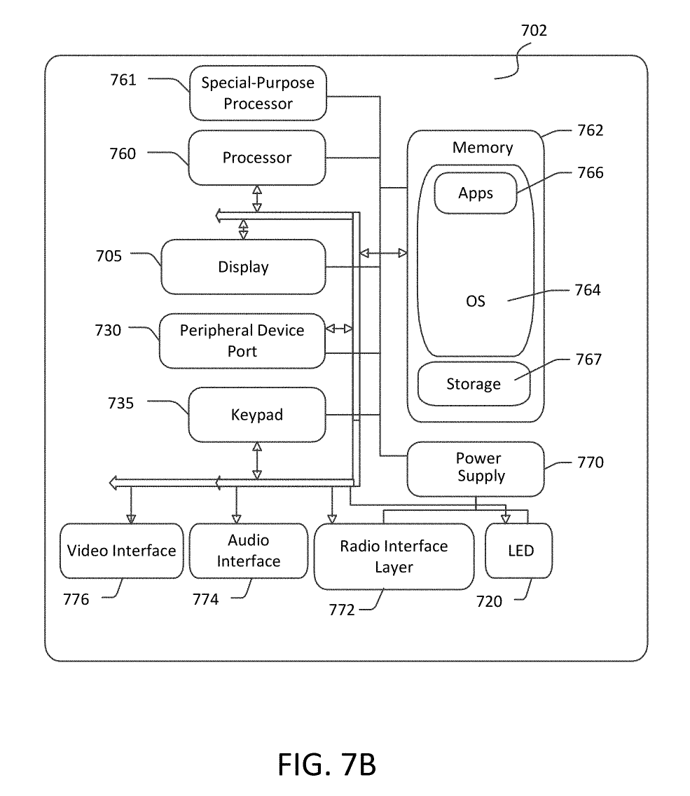

FIGS. 7A and 7B illustrate a mobile computing device 700, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 7A, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative aspects, mobile computing device 700 may incorporate more or less input elements. For example, the display 705 may not be a touch screen in some embodiments. In yet another alternative embodiment, the mobile computing device 700 is a portable phone system, such as a cellular phone. The mobile computing device 700 may also include an optional keypad 735. Optional keypad 735 may be a physical keypad or a “soft” keypad generated on the touch screen display. In various embodiments, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG. 7B is a block diagram illustrating the architecture of one aspect of a mobile computing device. That is, the mobile computing device 700 can incorporate a system (e.g., an architecture) 702 to implement some aspects. In one embodiment, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700, including the instructions for providing a unified messaging platform as described herein (e.g., search engine, extractor module, relevancy ranking module, answer scoring module, etc.).

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

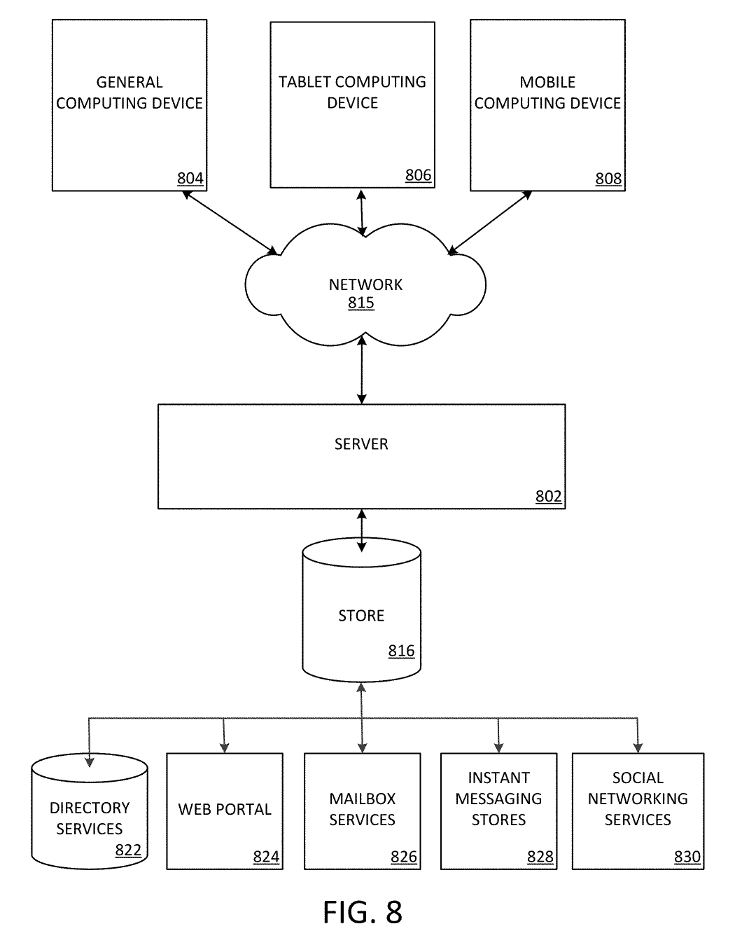

FIG. 8 illustrates one aspect of the architecture of a system for processing data received at a computing system from a remote source, such as a personal computer 804, tablet computing device 806, or mobile computing device 808, as described above. Content displayed at server device 802 may be stored in different communication channels or other storage types. For example, various documents may be stored using a directory service 822, a web portal 824, a mailbox service 826, an instant messaging store 828, or a social networking site 830. The unified messaging application 820 may be employed by a client that communicates with server device 802, and/or the unified messaging application 820 may be employed by server device 802. The server device 802 may provide data to and from a client computing device such as a personal computer 804, a tablet computing device 806 and/or a mobile computing device 808 (e.g., a smart phone) through a network 815. By way of example, the computer system described above with respect to FIGS. 1-5 may be embodied in a personal computer 804, a tablet computing device 806 and/or a mobile computing device 808 (e.g., a smart phone). Any of these embodiments of the computing devices may obtain content from the store 816, in addition to receiving graphical data useable to be either pre-processed at a graphic-originating system, or post-processed at a receiving computing system.

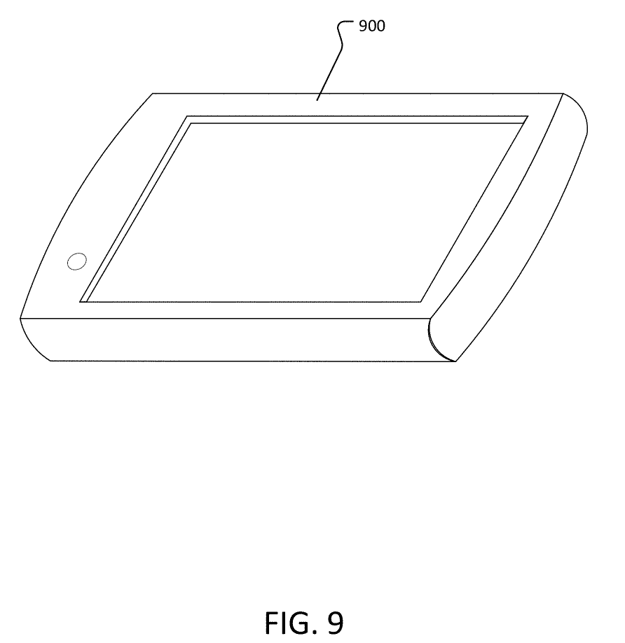

FIG. 9 illustrates an example tablet computing device 900 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory coupled to the at least one processor, the memory comprising computer executable instructions that, when executed by the at least one processor, performs a method for providing cloud-based activity information, the method comprising:
receiving activity information from a first device of a user;
processing the activity information to identify data associated with the first device;
based on the identified data, managing a mapping of a plurality of devices associated with the user, wherein the plurality of devices comprises at least the first device and a second device;
based on the mapping, configuring the activity information for use by the second device; and
sending the configured activity information to the second device.

2. The system of claim 1, wherein the activity information comprises at least one of: a notification, a task, a tile, a toast, a badge, and an information card.

3. The system of claim 1, wherein the identified data comprises at least one of: a user identification, an originating device, an originating device type, an originating application, service, and an activity information type.

4. The system of claim 1, wherein managing the mapping of a plurality of devices associated with the user comprises maintaining a data store of historical activity information for the plurality of devices.

5. The system of claim 4, wherein the historical activity information indicates devices having been identified as receiving the received activity information.

6. The system of claim 1, wherein the mapping of a plurality of devices associated with the user comprises at least one of: devices having been previously accessed by the user and devices authorized to transmit information with the first device.

7. The system of claim 1, wherein configuring the activity information for use by the second device comprises:
determining one or more characteristics of the second device; and
based on the one or more characteristics, packaging the activity information with information specific to the second device.

8. The system of claim 7, wherein packaging the activity information comprises including device-specific APIs to resolve local assets on the second device.

9. The system of claim 1, wherein managing the mapping accessing a user interface provided by the system, wherein the user interface enables one or more of:
viewing and manipulating activity information;
modifying user and application settings;
providing activity delivery details; and
developing third-party content.

10. A method for providing cloud-based activity information, the method comprising:
receiving activity information from a first device of a user;
processing the activity information to identify data associated with the first device;
based on the identified data, managing a mapping of a plurality of devices associated with the user, wherein the plurality of devices comprises at least the first device and a second device;
based on the mapping, configuring the activity information for use by the second device; and
sending the configured activity information to the second device.

11. The method of claim 1, wherein the identified data comprises at least one of: a user identification, an originating device, an originating device type, an originating application, service, and an activity information type.

12. The method of claim 1, wherein managing the mapping of a plurality of devices associated with the user comprises maintaining a data store of historical activity information for the plurality of devices, wherein the historical activity information indicates devices having been identified as receiving the received activity information.

13. The method of claim 1, wherein configuring the activity information for use by the second device comprises:
determining one or more characteristics of the second device; and
based on the one or more characteristics, packaging the activity information with information specific to the second device.

14. The method of claim 7, wherein packaging the activity information comprises including device-specific APIs to resolve local assets on the second device.

15. A system comprising:
at least one processor; and
memory coupled to the at least one processor, the memory comprising computer executable instructions that, when executed by the at least one processor, performs a method for providing cloud-based activity information, the method comprising:
receiving, from a first device of a user, an indication to activate actionable activity;
processing the indication to identify data associated with the first device;
based on the identified data, managing a mapping of a plurality of devices associated with the user, wherein the plurality of devices comprises at least the first device and a second device;
based on the mapping, determining the actionable activity is associated with the second device; and
transmitting the indication to the second device.

16. The system of claim 15, wherein the indication to activate actionable activity corresponds to at least one of: clicking on a link and selecting actionable activity information.

17. The system of claim 15, wherein processing the indication comprises at least one of: identifying a device originating the actionable activity, identifying a device operable to perform the actionable activity, performing an event associated with the actionable activity, and generating an actionable activity payload.

18. The system of claim 15, wherein the method further comprises:
receiving an activation notification from the second device;
accessing a data store comprising historical activity information for the plurality of devices to determine devices that have not received the activation notification;
transmitting the activation notification to the determined devices; and
updating the data store for the determined devices.

19. The system of claim 18, transmitting the activation notification to the determined devices comprises generating payloads including instructions preventing the indication from being reactivated.

20. The system of claim 19, wherein the payloads further include instructions to remove the indication from the receiving device.
